(19) United States
(12) Patent Application Publication
(10) Pub. No.: US 2026/0274057 A1
(43) Pub. Date: Sep. 17, 2026

(54) BATTERY SYSTEM FOR VEHICLE

(71) Applicants: Hyundai Motor Company, Seoul (KR); Kia Corporation, Seoul (KR)

(72) Inventors: Eung Gyu LEE, Hwaseong-si (KR); Hyun Woo YOON, Hwaseong-si (KR); Jong Gyu PARK, Hwaseong-si (KR)

(21) Appl. No.: 19/283,675

(22) Filed: Jul. 29, 2025

(30) Foreign Application Priority Data
Mar. 11, 2025 (KR) 10-2025-0031489

(51) Int. Cl. B60K 1/04; B60K 1/00; B60L 50/60; H01M 10/613; H01M 10/625; H01M 10/653; H01M 10/6556; H01M 10/656; H01M 50/204; H01M 50/249; H01M 50/289

(52) U.S. Cl. CPC B60K 1/04; B60L 50/66; H01M 10/613; H01M 10/625; H01M 10/653; H01M 10/6556; H01M 10/656; H01M 50/204; H01M 50/249; H01M 50/289; B60K 2001/005; B60K 2001/0438; H01M 2220/20

(57) ABSTRACT

A battery system for a vehicle includes a cartridge that is configured to be coupled to a vehicle body of the vehicle and open at upper and lower sides thereof, a cooling block coupled to any one of the upper or lower side of the cartridge, and a battery pack configured to exchange heat with the cooling block in a state in which the battery pack is inserted into an internal space of the cartridge through the other of the upper or lower side of the cartridge.

### CROSS-REFERENCE TO RELATED APPLICATION

The present application claims priority of Korean Patent Application No. 10-2025-0031489, filed on Mar. 11, 2025, the entire contents of which are incorporated herein for all purposes by this reference.

### TECHNICAL FIELD

The present disclosure relates to a battery system for a vehicle, and more particularly a battery system including a cartridge, a cooling block, and a battery pack.

### BACKGROUND

Various carbon reduction technologies may solve environmental issues such as abnormal weather. For instance, electrical energy may be utilized in vehicles, industrial sites, and homes. In some cases, battery systems in electric vehicles account for a large proportion of vehicle price. Battery swapping systems may provide a method of reducing consumer burdens and improving marketability of electric vehicles.

For example, the battery swapping system may mechanically separate a discharged battery pack of the electric vehicle and replace the discharged battery pack with a fully charged battery pack by an automated platform or station. The battery swapping system may provide flexibility in selecting the number of battery packs to be replaced depending on operational circumstances.

In some cases, because the battery pack generates heat while when in use, a cooling structure for effective heat exchange may be provided to maintain stable performance.

In some battery swapping systems, each of the battery packs may have an independent cooling structure, which may increase a space for the cooling structure and include separated inlet and discharge pipes to supply a cooling medium during the replacement process. In some cases, the pipes may leak and lose the cooling medium.

### SUMMARY

The present disclosure describes a battery system including a cartridge fixed to a vehicle body and opened at upper and lower sides thereof, a cooling block fixed and coupled to any one of the upper and lower sides of the cartridge, and a battery pack configured to exchange heat with the cooling block in a state in which the battery pack is inserted into an internal space of the cartridge through the other of the upper and lower sides of the cartridge.

According to one aspect of the subject matter described in this application, a battery system for a vehicle includes a cartridge that is configured to be coupled to a vehicle body of the vehicle, the cartridge defining an internal space that is open at upper and lower sides thereof, a cooling block coupled to one of the upper side or the lower side of the cartridge, the cooling block defining a cooling flow path configured to carry a cooling medium, and one or more battery packs inserted into the internal space of the cartridges through the other of the upper side or the lower side of the cartridge, the one or more battery packs being configured to be assembled to the cartridge or the vehicle body and to exchange heat with the cooling block.

Implementations according to this aspect can include one or more of the following features. For example, the cooling block can be coupled to the upper side of the cartridge, where the one or more battery packs can be inserted into the internal space of the cartridge through the lower side of the cartridge. In some implementations, the cartridge can be configured to be disposed at a lower portion of the vehicle, where the one or more battery packs can be configured to be inserted into the cartridge from below the vehicle.

In some implementations, the battery system can further include a cross-member that traverses the internal space of the cartridge, that is disposed in the cartridge, and that divides the internal space of the cartridge into a plurality of spaces. In some implementations, the battery system can further include a thermal conduction pad that is disposed between the one or more battery packs and the cooling block and that is configured to exchange heat with the one or more battery packs and the cooling block.

In some examples, an outside of each of the one or more battery packs can be sealed. In implementations, each of the one or more battery packs can include a pack connector that is oriented toward the cooling block. In some examples, an uppermost end of the pack connector can be disposed lower than a surface of the one or more battery packs that faces the cooling block.

In some implementations, the cooling block can define a through-hole at a position corresponding to the pack connector. In some examples, the battery system can further include a connection line that is coupled to an outer surface of the cooling block and that is configured to (i) connect the one or more battery packs to the vehicle or (ii) connect adjacent battery packs of the one or more battery packs to each other, where the connection line passes through the through-hole and is connected to the pack connector.

In some implementations, the battery system can further include a vehicle connector that is disposed at the cartridge, where the connection line connects the pack connector to the vehicle connector. In some examples, the cartridge can define an installation groove that is recessed from an outer side of the cartridge and receives the vehicle connector.

In some implementations, the cooling block can include an inlet pipe configured to receive the cooling medium, and a discharge pipe disposed adjacent to the inlet pipe and configured to discharge the cooling medium. In some examples, the cooling flow path can have a spiral shape. In some implementations, the cooling flow path has (i) a first end defined at an outer portion of the cooling block and (ii) a second end defined at a central portion of the cooling block.

In some examples, the cooling block can further define an auxiliary flow path that is arranged outside the cooling flow path and connected to the second end of the cooling flow path. In some implementations, the battery system can further include a bridge block that connects the second end of the cooling flow path connected to a first end of the auxiliary flow path, where a second end of the auxiliary flow path is disposed adjacent to the first end of the cooling flow path.

In some implementations, a width of the auxiliary flow path can be less than a width of the cooling flow path. In some examples, the bridge block can be disposed at a surface of the cooling block facing the one or more battery packs, the bridge block being spaced apart from the one or more battery packs.

According to another aspect, a vehicle include the battery system described above.

In some implementations, where one or the plurality of battery packs exchange heat with one cooling block, a separate cooling structure may not be provided in each of the battery packs. As such, the battery system can reduce a space waste and increase the energy payload and energy density in the same space. Further, the cooling block may not be replaced when the battery pack is replaced, which can reduce or minimize a leak and loss of the cooling medium.

### BRIEF DESCRIPTION OF THE DRAWINGS

FIG. 1 is a view illustrating an example of a battery system for a vehicle.

FIG. 2 is an exploded perspective view of the battery system.

FIG. 3 is a view illustrating an example of a cartridge.

FIG. 4 is an exploded perspective view illustrating an example of a cooling block.

FIG. 5 is a view for explaining an example of a flow of a cooling medium in a cooling flow path.

FIG. 6 is an exploded perspective view showing an example of a battery pack.

FIG. 7 is a cross-sectional view of the battery system.

FIG. 8 is a view illustrating an example of a vehicle including the battery system.

### DETAILED DESCRIPTION

Hereinafter, various implementations disclosed in the present specification will be described in detail with reference to the accompanying drawings. The same or similar constituent elements are assigned with the same reference numerals regardless of reference numerals, and the repetitive description thereof will be omitted.

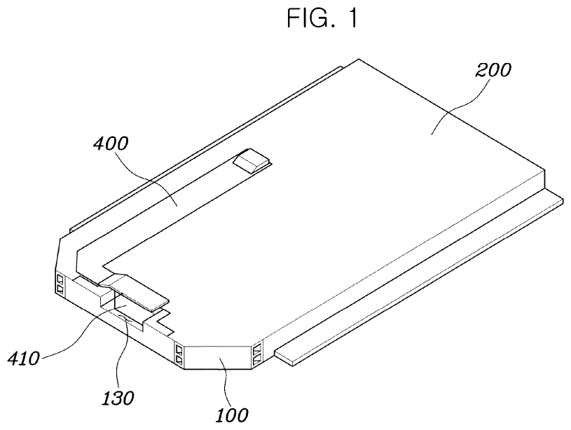

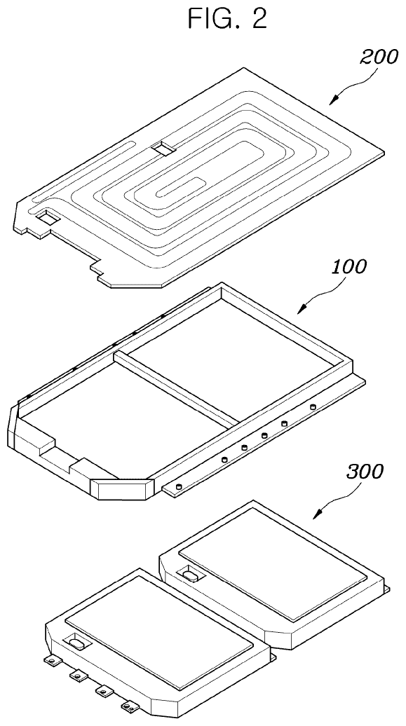

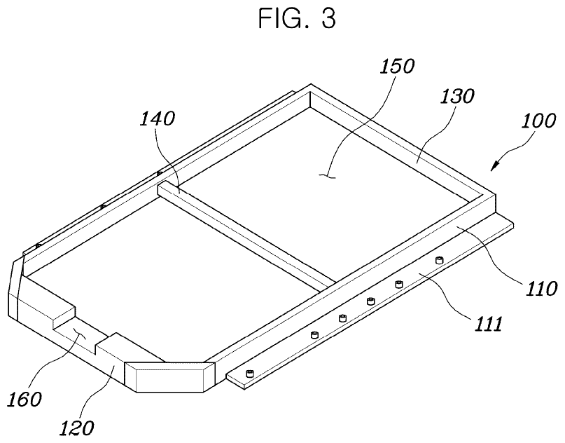

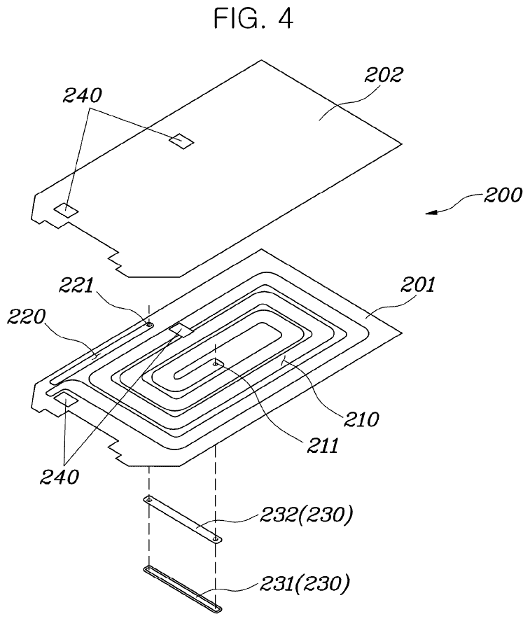

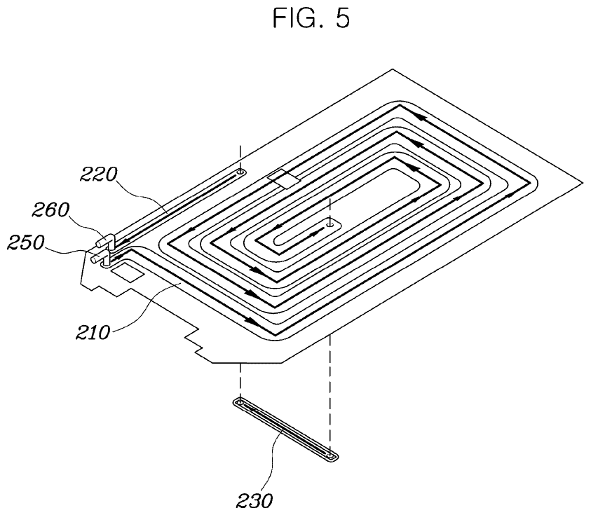

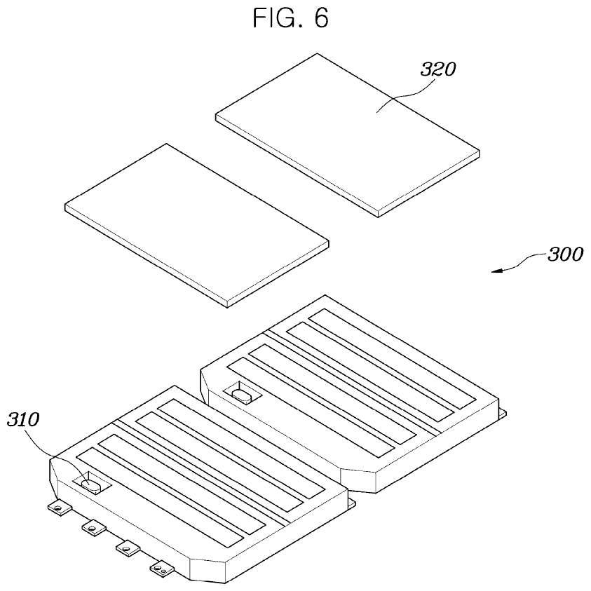

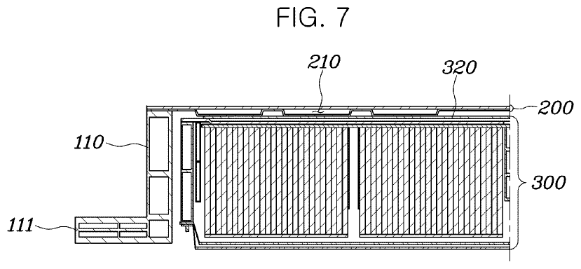

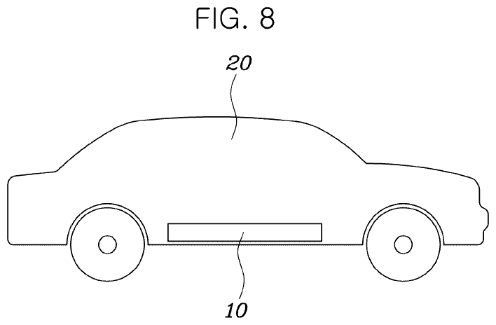

FIG. 1 is a view illustrating an example of a battery system for a vehicle, FIG. 2 is an exploded perspective view of the battery system, FIG. 3 is a view illustrating an example of a cartridge, FIG. 4 is an exploded perspective view showing an example of a cooling block, FIG. 5 is a view for explaining an example of a flow of a cooling medium in a cooling flow path, FIG. 6 is an exploded perspective view of an example of a battery pack, FIG. 7 is a cross-sectional view of the battery system, and FIG. 8 is a view illustrating an example of a vehicle including the battery system.

As described above, in the case of a general battery swapping system, each battery pack has an independent cooling structure. However, this configuration not only increases a space for the cooling structure but also includes separated inlet and discharge pipes that supply a cooling medium during a process of replacing the battery pack, which can cause a problem of a leak and loss of the cooling medium.

Therefore, the present disclosure is intended to provide a battery system for a vehicle, the battery system including a cartridge fixed to a vehicle body and opened at upper and lower sides thereof, a cooling block fixed and coupled to any one of the upper and lower sides of the cartridge, and a battery pack configured to exchange heat with the cooling block in a state in which the battery pack is inserted into an internal space of the cartridge through the other of the upper and lower sides of the cartridge, which solves the above-mentioned problem.

The present disclosure will be described in which the battery system for a vehicle is a battery swapping system, but this is for convenience of description. In interpreting the protection scope, the protection scope should not be limited by the designation. The protection scope should be interpreted as covering various structures and systems capable of storing and supplying electrical energy of vehicles.

In addition, the present disclosure can be applied to various vehicles such as electric vehicles, fuel cell electric vehicles, or hybrid vehicles in which batteries are coupled to lower portions of the vehicles. That is, the protection scope of the present disclosure applies to various structures and systems capable of storing and supplying electrical energy to the vehicles regardless of types of vehicles.

In addition, the protection scope of the present disclosure can also apply to various fields such as industrial energy storage systems (ESSs), household ESSs, or small-scale battery systems in addition to the vehicle.

A battery system for a vehicle the present disclosure can include a cartridge 100 fixed to a vehicle body and having an internal space 150, the internal space 150 being opened at upper and lower sides thereof, a cooling block 200 coupled and fixed to any one of the upper and lower sides of the cartridge 100 and having a cooling flow path 210 in which a cooling medium flows, and one or a plurality of battery packs 300 inserted into the internal space 150 through the other of the upper and lower sides of the cartridge 100, assembled to the cartridge 100 or the vehicle body, and configured to exchange heat with the cooling block 200 in a state in which the battery packs 300 are inserted into the cartridge 100.

Because one battery pack 300 or the plurality of battery packs 300 can exchange heat with one cooling block 200, space waste caused by the cooling structure can be reduced or minimized, which can increase energy payload and energy density in the same space. Because an inlet pipe 250 and a discharge pipe 260 of the cooling block 200 may not be separated or reassembled in case that the battery pack 300 is replaced, it can be possible to reduce or minimize a leak and loss of the cooling medium caused during the process.

In some implementations, the cartridge 100 is fixed to the vehicle body and has the internal space 150, and the upper and lower sides of the internal space 150 can be opened.

With reference to FIG. 3, in some examples, the cartridge 100 can include a pair of lateral members 110 spaced apart from each other, extending, and disposed at two opposite sides, a front member 120 configured to connect front ends of the pair of lateral members 110, and a rear member 130 configured to connect rear ends of the pair of lateral members 110.

In some implementations, the lateral members 110 can each include a flange 111 protruding laterally from an outer side of the lateral member 110 and extending in a direction identical to a direction in which the lateral member extends. The flange 111 can be coupled to the vehicle body at a plurality of coupling points. With this structure, the battery system for a vehicle can be coupled and fixed to the vehicle body.

In some implementations, as described above, an upper portion of the front member 120 is recessed, such that an installation groove 160 can be formed. A vehicle connector 410 can be disposed in the installation groove 160.

In some examples, the cartridge 100 can have the internal space 150 surrounded by the pair of lateral members 110, the front member 120, and the rear member 130. One or a plurality of cross-members 140 can be disposed to traverse the internal space, support the pair of lateral members, and define a load path for dispersing external load and impact. For example, the cartridge 100 can have a frame shape defined by the pair of lateral members 110 (lateral walls), the front member 120 (front wall), and the rear member 130 (rear wall).

In addition, the cross-member 140 can divide the internal space 150 into a plurality of spaces, and the battery pack 300 can be inserted into each of the spaces. For example, the cross-member 140 can be a cross-bar.

In some examples, the lateral member 110, the front member 120, the rear member 130, and the cross-member 140 of the cartridge 100 can be formed by extrusion, and the extrusion directions of the members can perpendicularly intersect one another or be parallel to one another. In more detail, the lateral member 110 can be extruded in a longitudinal direction of the vehicle, and the front member 120, the rear member 130, and the cross-member 140 can be extruded in a width direction of the vehicle so as to be perpendicular to the extrusion direction of the lateral member 110, which can more effectively withstand an external load.

In some implementations, the lateral member 110, the front member 120, the rear member 130, and the cross-member 140 are formed to have hollow structures, which can reduce weights. In addition, one or a plurality of ribs are formed in the hollow structure to reinforce rigidity.

In some examples, where the cartridge 100 protects the battery pack 300 inserted into the internal space 150, the cartridge 100 can be made of a material with comparatively high rigidity, e.g., a metallic material. For instance, the cartridge can be made of aluminum (Al), which is a metallic material, in order to ensure formability and reduce a weight. However, this configuration is illustrative, and the material of the cartridge 100 is not limited thereto.

In some examples, the pair of lateral members 110, the front member 120, the rear member 130, and the cross-member 140 can be coupled in various ways such as bonding, mechanical fastening, and welding, e.g., coupled to one another by welding.

In some examples, the cooling block 200 can be coupled and fixed to any one of the upper and lower sides of the cartridge 100 and have the cooling flow path 210 in which the cooling medium flows.

With reference to FIG. 2, in some implementations, through-holes 240 can be formed through the cooling block 200 and provided at positions corresponding to pack connectors 310 of the battery packs 300, such that the pack connectors 310 of the battery packs 300 can be electrically connected to the vehicles without interfering with the cooling block 200.

In some examples, the cooling block 200 can have a shape corresponding to the cartridge 100 and be coupled to the upper or lower side of the cartridge 100 to cover the upper or lower side of the cartridge 100.

In some examples, the cooling block 200 can have the inlet pipe 250 through which the cooling medium is introduced into the cooling block 200 from the outside, and the discharge pipe 260 through which the cooling medium is discharged from the inside of the cooling block 200 to the outside. The inlet pipe 250 and the discharge pipe 260 can be disposed adjacent to each other. In more detail, the inlet pipe 250 and the discharge pipe 260 can be adjacent to each other and disposed at an outer front side of the cooling block 200. This structure may not include a complicated pipe or an additional component, which can reduce costs and spaces for such components, and facilitate maintenance and assembling processes.

In some examples, the cooling flow path 210 can be formed spirally, such that a contact area with the battery pack 300 can be increased, and heat exchange efficiency between the cooling block 200 and the battery pack 300 can be improved. Therefore, a temperature deviation and temperature imbalance of the battery pack 300 can be reduced, and the performance and lifespan of the battery system for a vehicle can be improved.

In some implementations, an auxiliary flow path 220 can be formed outside the cooling flow path 210 and extend along an outer portion of the cooling block 200.

In some implementations, the cooling flow path 210 and the auxiliary flow path 220 can be connected by a bridge block 230. In more detail, the inlet pipe 250 can be connected to one end of the cooling flow path 210, the other end of the cooling flow path 210 can be connected to one end of the bridge block 230, the other end of the bridge block 230 can be connected to one end of the auxiliary flow path 220, and the other end of the auxiliary flow path 220 can be connected to the discharge pipe 260. The bridge block 230 can be formed in the bridge block 230 and connect the cooling flow path 210 and the auxiliary flow path 220.

With reference to FIG. 4, in some examples, the cooling block 200 can include a first plate 201 having the cooling flow path 210 and the auxiliary flow path 220, and a second plate 202 that is a flat plate corresponding in shape to the first plate 201. The first plate 201 and the second plate 202 can be coupled in various ways such as bonding, mechanical fastening, and welding, e.g., coupled to each other by bonding.

In some examples, the through-holes 240 can be formed in the first plate 201 and the second plate 202 and provided at positions corresponding to one another. The through-holes 240 of the first and second plates 201 and 202 can be tightly attached to one another and sealed to prevent a leak of the cooling medium through the through-holes 240.

In some implementations, the bridge block 230 can include a first bridge plate 231 having a forming portion 233, and a second bridge plate 232 that is a flat plate corresponding in shape to the first bridge plate 231.

In some implementations, first holes 211 can be formed in the cooling flow path and the bridge block 230 and provided at positions corresponding to each other, and second holes 221 can be formed in the auxiliary flow path and the bridge block 230 and provided at positions corresponding to each other.

In more detail, the first holes 211 can be respectively formed at one end of the second bridge plate 232 connected to the cooling flow path 210 and the point on the cooling flow path 210 connected to the bridge block 230, and the second holes 221 can be respectively formed at the other end of the second bridge plate 232 connected to the auxiliary flow path 220 and the point on the auxiliary flow path 220 connected to the bridge block 230. Meanwhile, a diameter of the first hole 211 can be larger than a diameter of the second hole 221.

With reference to FIG. 5, in some examples, one end of the cooling flow path 210 can be formed outside the cooling block 200, the other end of the cooling flow path 210 can be formed at a central portion of the cooling block 200, and the cooling flow path 210 can have a spiral shape. In more detail, one end of the cooling flow path 210 can be connected to the inlet pipe 250, such that the cooling medium can be introduced into the cooling block 200 and flow along the spiral cooling flow path 210 to the other end of the cooling flow path 210 positioned at the central portion of the cooling block 200 while exchanging heat with the battery pack 300.

In some implementations, the auxiliary flow path 220 can be formed along an outer portion of the cooling block 200 and connected to the other end of the cooling flow path 210. In more detail, the other end of the cooling flow path 210 can be connected to one end of the auxiliary flow path 220 through the bridge block 230, such that the cooling medium can flow from the cooling flow path 210 to the auxiliary flow path 220 through the bridge block 230. The other end of the auxiliary flow path 220 can be disposed adjacent to one end of the cooling flow path 210 and connected to the discharge pipe 260, such that the cooling medium having exchanged heat with the battery pack 300 can be discharged to the outside of the cooling block 200 through the discharge pipe 260.

In some examples, because a width of the auxiliary flow path 220 is smaller than a width of the cooling flow path 210, a flow velocity of the cooling medium is relatively low in the cooling flow path 210, such that the cooling medium can exchange heat with the battery pack 300 for a long period of time. Because a flow velocity of the cooling medium is relatively high in the auxiliary flow path 220, the cooling medium having exchanged heat can be quickly discharged.

In some implementations, the bridge block 230 can be disposed on a surface of the cooling block 200 that faces the battery pack 300, and the bridge block 230 is disposed to avoid the battery pack 300, which can prevent interference between the battery pack 300 and the bridge block 230 and allow the remaining portion of the cooling block and the battery pack to adjoin each other more effectively.

In some examples, the battery pack 300 can be inserted into the internal space 150 through the other of the upper and lower sides of the cartridge 100 and assembled to the cartridge 100 or the vehicle body.

With reference to FIG. 2, in some implementations, the plurality of battery packs 300 can be provided, inserted into the internal space 150 of the cartridge 100, and assembled to the cartridge 100 or the vehicle body. In more detail, the battery pack can be inserted into each of the plurality of spaces defined by the cross-member.

With reference to FIG. 6, in some examples, the battery pack 300 can have the pack connector 310 directed toward the cooling block 200. A thermal conduction pad 320 can be disposed on a surface of the battery pack 300 directed toward the cooling block 200. In more detail, the pack connector 310 can be formed to be directed upward, and the thermal conduction pad 320 can be disposed on an upper surface of the battery pack 300. In addition, a height of an uppermost end of the pack connector 310 is lower than a height of a surface of the battery pack that exchanges heat with the cooling block, which can prevent the battery pack 300 from interfering with the cooling block 200 inserted into the cartridge 100 and coupled to the cartridge 100.

In some implementations, the battery pack 300 can have a shape sealed from the outside. Because the battery pack 300 can be inserted into the vehicle or separated from the vehicle and replaced, the battery pack 300 can be sealed from the outside, such that the sealability can be ensured.

In some examples, the battery pack 300 can exchange heat with the cooling block 200 in the state in which the battery pack 300 is inserted into the cartridge 100.

With reference to FIG. 7, in some implementations, the battery pack 300 and the cooling block can be in surface contact with each other and exchange heat with each other. The thermal conduction pad 320 can be disposed between the battery pack 300 and the cooling block 200, such that the cooling block 200 and the battery pack 300 can exchange heat with each other by means of thermal conduction.

In some examples, the battery pack 300 can have a plurality of battery cells. In more detail, the plurality of battery cells can be embedded in an intermediate form of a module or an assembly (cell module assembly). The module or the assembly can be configured by assembling the plurality of battery cells into one module or assembly. A plurality of modules or assemblies can be provided in the battery pack 300 and constitute the battery pack 300.

With reference to FIG. 1, in some examples, a connection line 400 can be coupled to an outer surface of the cooling block 200. The connection line 400 can connect the battery pack 300 and the vehicle or connect the adjacent battery packs 300.

With reference to FIGS. 1 and 2, in some examples, the connection line 400 can pass through the through-hole 240 formed in the cooling block 200, and the connection line 400 can be connected to the pack connector 310 of the battery pack 300. In more detail, the connection line 400 can extend to pass through the through-hole 240, and the connection line 400 can be bent at a point on the cartridge 100 adjacent to the front member 120 and disposed in parallel with the front member 120.

In some examples, the vehicle connector 410 can be disposed on the cartridge 100. The connection line 400 can connect the pack connector 310 and the vehicle connector 410.

In some examples, the installation groove 160 can be formed by recessing an outer side of the cartridge 100, and the vehicle connector 410 can be disposed in the installation groove 160. In more detail, a front end of the cartridge 100, i.e., a central portion of the front member 120 can be recessed downward, such that the installation groove 160 can be formed. One side of the vehicle connector 410 can be disposed in the installation groove 160 and directed forward.

With reference to FIG. 8, in some examples, a battery system 10 for a vehicle can be provided on a lower portion of a vehicle 20. In more detail, the cartridge 100 can be provided on the lower portion of the vehicle 20, and the battery pack 300 can be inserted into the cartridge 100 from below the vehicle 20. However, this is provided for illustrative purposes only. The cartridge 100 can be disposed at various positions on the vehicle 20 and coupled to the vehicle.

While the specific implementations of the present disclosure have been illustrated and described, it will be obvious to those skilled in the art that the present disclosure can be variously modified and changed without departing from the technical spirit of the present disclosure defined in the appended claims.

What is claimed is:

1. A battery system for a vehicle, the battery system comprising:
a cartridge that is configured to be coupled to a vehicle body of the vehicle, the cartridge defining an internal space that is open at upper and lower sides thereof;
a cooling block coupled to one of the upper side or the lower side of the cartridge, the cooling block defining a cooling flow path configured to carry a cooling medium; and
one or more battery packs inserted into the internal space of the cartridges through the other of the upper side or the lower side of the cartridge, the one or more battery packs being configured to be assembled to the cartridge or the vehicle body and to exchange heat with the cooling block.

2. The battery system of claim 1, wherein the cooling block is coupled to the upper side of the cartridge, and
wherein the one or more battery packs are inserted into the internal space of the cartridge through the lower side of the cartridge.

3. The battery system of claim 1, wherein the cartridge is configured to be disposed at a lower portion of the vehicle, and
wherein the one or more battery packs are configured to be inserted into the cartridge from below the vehicle.

4. The battery system of claim 1, further comprising a cross-member that traverses the internal space of the cartridge, that is disposed in the cartridge, and that divides the internal space of the cartridge into a plurality of spaces.

5. The battery system of claim 1, further comprising a thermal conduction pad that is disposed between the one or more battery packs and the cooling block and that is configured to exchange heat with the one or more battery packs and the cooling block.

6. The battery system of claim 1, wherein an outside of each of the one or more battery packs is sealed.

7. The battery system of claim 1, wherein each of the one or more battery packs comprises a pack connector that is oriented toward the cooling block.

8. The battery system of claim 7, wherein an uppermost end of the pack connector is disposed lower than a surface of the one or more battery packs that faces the cooling block.

9. The battery system of claim 8, wherein the cooling block defines a through-hole at a position corresponding to the pack connector.

10. The battery system of claim 9, further comprising a connection line that is coupled to an outer surface of the cooling block and that is configured to (i) connect the one or more battery packs to the vehicle or (ii) connect adjacent battery packs of the one or more battery packs to each other,
wherein the connection line passes through the through-hole and is connected to the pack connector.

11. The battery system of claim 10, further comprising a vehicle connector that is disposed at the cartridge,
wherein the connection line connects the pack connector to the vehicle connector.

12. The battery system of claim 11, wherein the cartridge defines an installation groove that is recessed from an outer side of the cartridge and receives the vehicle connector.

13. The battery system of claim 1, wherein the cooling block comprises:
an inlet pipe configured to receive the cooling medium; and
a discharge pipe disposed adjacent to the inlet pipe and configured to discharge the cooling medium.

14. The battery system of claim 1, wherein the cooling flow path has a spiral shape.

15. The battery system of claim 14, wherein the cooling flow path has (i) a first end defined at an outer portion of the cooling block and (ii) a second end defined at a central portion of the cooling block.

16. The battery system of claim 15, wherein the cooling block further defines an auxiliary flow path that is arranged outside the cooling flow path and connected to the second end of the cooling flow path.

17. The battery system of claim 16, further comprising a bridge block that connects the second end of the cooling flow path connected to a first end of the auxiliary flow path,
wherein a second end of the auxiliary flow path is disposed adjacent to the first end of the cooling flow path.

18. The battery system of claim 17, wherein a width of the auxiliary flow path is less than a width of the cooling flow path.

19. The battery system of claim 17, wherein the bridge block is disposed at a surface of the cooling block facing the one or more battery packs, the bridge block being spaced apart from the one or more battery packs.

20. The vehicle comprising the battery system of claim 1.
